(19) United States
(12) Patent Application Publication
(10) Pub. No.: US 2021/0016952 A1
(43) Pub. Date: Jan. 21, 2021

(54) STORAGE DEVICE WITH MAINTAINED ATMOSPHERIC CONTROL

(71) Applicant: Gideon Duval, Atlanta, GA (US)

(72) Inventor: Gideon Duval, Atlanta, GA (US)

(21) Appl. No.: 16/933,990

(22) Filed: Jul. 20, 2020

Related U.S. Application Data
(60) Provisional application No. 62/876,418, filed on Jul. 19, 2019.

(51) Int. Cl. B65D 81/20; A23L 3/3418

(52) U.S. Cl. CPC B65D 81/2069; A23L 3/3418

(57) ABSTRACT

A storage device composed of a chamber with an interior volume configured to receive media in fluid connection with a storage valve configured to selectively control the flow of media and ambient atmosphere, the storage valve in fluid communication with a dock configured to sealingly engage with an additional storage device. The dock configured to facilitate the passage of media without exposure to an ambient atmosphere.

### CROSS-REFERENCE TO RELATED APPLICATION

This application claims priority to, U.S. provisional patent application Ser. No. 62/876,418, filed on Jul. 19, 2019, the entirety of all are is incorporated by reference.

### FIELD OF THE INVENTION

The present invention discloses a system for storing and transferring media in containers with constant atmospheric control.

### BACKGROUND OF THE INVENTION

The storage of media in controlled atmospheres has been well established benefits in a multitude of fields including food preservation. One problem with accessing media stored in a controlled atmosphere is the act of accessing the media typically results in the loss of the controlled atmosphere. Thus, there is a need for a system for storing media in a controlled atmosphere and readily accessed whereby the atmosphere may be controlled continually.

### SUMMARY OF THE INVENTION

The present invention relates to a storage device that satisfies the outlined need, facilitating the storage of media within a controlled atmosphere while allowing the selective insertion and removal of media from the storage device while maintaining a controlled atmosphere within the storage device. An exemplary system is composed of a chamber with an interior volume configured to receive media in fluid connection with a storage valve configured to selectively control the flow of media and ambient atmosphere, the storage valve in fluid communication with a dock configured to sealingly engage with an additional storage device. The dock configured to facilitate the passage of media without exposure to an ambient atmosphere.

### BRIEF DESCRIPTION OF THE DRAWING

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 Illustrates a schematic of the disclosed invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

Although the invention is illustrated and described herein with reference to specific embodiments, the invention is not intended to be limited to the details shown. Rather, various modifications may be made in the details within the scope and range of equivalents of the claims and without departing from the invention.

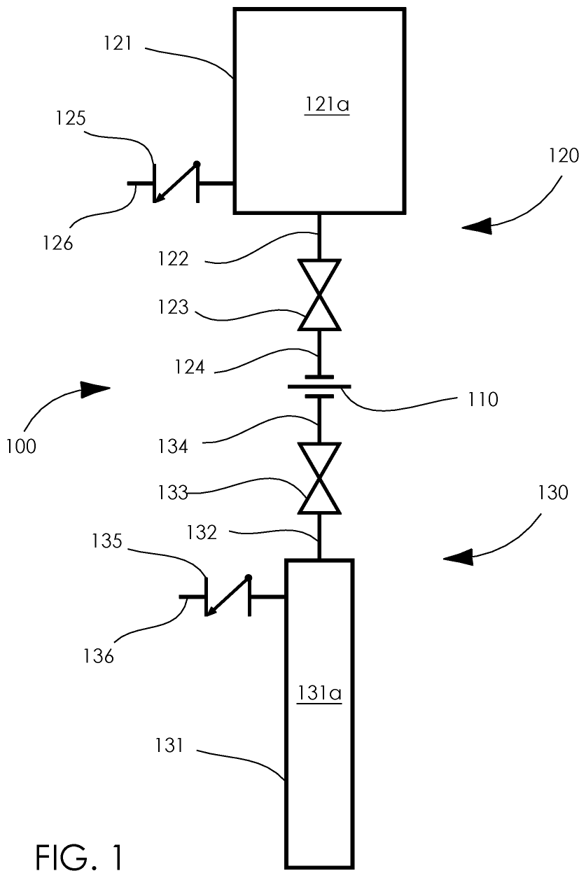

Depicted in FIG. 1 is a device 100 that meets the aforementioned need for a system by which media may be stored in a controlled atmosphere and readily accessed whereby the atmosphere may be controlled continually. Device 100 is composed of two components, primary storage container 120 and secondary storage container 130 which are selectively connected by container dock 110 that sealingly connects both primary storage container 120 and secondary storage container 130 in a temporary fashion and configured whereby media may be selectively transferred between said storage containers while maintaining a controlled internal atmosphere.

Primary storage container 120 is composed of storage chamber 121 forming chamber interior volume 121a with media transport pathway 122 connecting the chamber interior volume 121a of storage chamber 121 with primary storage valve 123. Valve-dock media transport pathway 124 connects primary storage valve 123 with container dock 110 facilitating the transport of media. Valve 125 and fluid port 126 may also be coupled to primary storage container 120 whereby it may selectively control the ingress or egress of fluid within chamber interior volume 121a whereby its internal atmosphere may be selectively modified as desired by a user. In the depicted example, valve 125 and fluid port 126 are physically and fluidically coupled to storage chamber 121 however they may be connected in alternate locations as long as fluidic connectivity to chamber interior volume 121a is maintained.

Primary storage container 130 is composed of storage chamber 131 forming chamber interior volume 131a with media transport pathway 132 connecting the chamber interior volume 131a of storage chamber 131 with storage valve 133. Valve-dock media transport pathway 134 connects primary storage valve 133 with container dock 110 facilitating the transport of media. Valve 135 and fluid port 136 may also be coupled to primary storage container 130 whereby it may selectively control the ingress or egress of fluid within chamber interior volume 131a whereby its internal atmosphere may be selectively modified as desired by a user. In the depicted example, valve 135 and fluid port 136 are physically and fluidically coupled to storage chamber 131 however they may be connected in alternate locations as long as fluidic connectivity to chamber interior volume 131a is maintained.

Container dock 110 may be composed of more than one component and is preferably formed by at least two parts each mechanically coupled to primary storage container 120 and secondary storage container 130 whereby their union forms a sealed connection preventing the ingress or egress of the ambient atmosphere and forming a fluidic pathway linking their internal atmospheres and allowing movement of media between primary storage container 120 and secondary storage container 130. In a preferred embodiment, container dock 110 is formed by the union of valve-dock media transport pathway 124 and valve-dock media transport pathway 134. A multitude of methods may be utilized to form container dock 110 however an exemplary method would be through the use of male and female tapered threads where by their assembly would produce a sealed connection and internal pathway for media flow. An alternate embodiment may utilize male and female straight threads and the incorporation of a seal whereby said seal is engaged during the engagement of the threads and union of primary storage container 120 and secondary storage container 130 forming dock 110 and its internal media pathway.

In use, primary storage container 120 and secondary storage container 130 may be operated in an identical fashion whereby media may be loaded into and removed from and transferred between in the following manner. Primary storage container 120 and secondary storage container 130 have media loaded into them when they are disconnected at container dock 110 and storage valves 123 and 133 are in the open position. Media may be loaded or removed from the containers by inserting media through dock media transport pathways 124 and 134 through open primary storage valves 123 and 133 through media transport pathway 122 and 132 into chamber interior volume 131a and 121a. This flow of media may be reversed during the media removal process. Once media has been either removed or inserted into chamber interior volumes 121a and 131a. Storage valves 123 and 133 are closed whereby chamber interior volumes 121a and 131a are sealed from the ambient atmosphere and an internal atmosphere is maintained. Valves 125 and 135 may be configured to allow for the movement of fluid in either desired direction in the event that a pressure differential between the ambient and internal atmospheres exceeds a desired value. Additionally, fluid ports 126 and 136 may be used to selectively insert or remove fluid from chamber interior volumes 121a and 131a as desired thereby altering their respective atmospheres.

Media may be transferred between primary storage container 120 and secondary storage containers 130 by joining them by connecting them forming container dock 110 and then opening storage valves 123 and 133 whereby interior volumes 121a and 13 la are in fluidic connection and isolated from the ambient atmosphere. Media may then be transferred between through means such as gravity feeding. Once the media has been transferred, storage valves 123 and 133 may be closed and primary storage container 120 and 130 may be disconnected at dock 110.

Storage chambers 121 and 131 may be composed of various materials including plastics. It may be found advantageous to use a transparent material such as clear plastic or glass whereby the media inside may be visually apparent. Additionally, storage chambers 121 and 131 may take various shapes and sizes however they should be conducive to the transfer of media and may include a graduated scale whereby the amount of media inside may be measured. It may be found advantageous for storage chambers 121 and 131 to be composed of two components whereby they may be disassembled for cleaning.

Additionally, it may be found advantageous for at least one of storage chambers 121 and 131 to be of a high aspect ratio, greater than 1:1 such as between 1:2 and 1:20 whereby an internal media volume may be measured with a higher accuracy.

Storage valves 123 and 133 may be composed of any valve style that enables selective closing and opening along with a minimally contorted flow path whereby media may be easily transferred. Exemplary valves include ball, butterfly, gate, pinch, and plug valves.

In an alternate embodiment, valves 125, and 135 or additional valves, not depicted in FIG. 1, may be in fluidic connection with interior volumes 121a and 131a whereby a fluid may be selectively introduced therein. Such a fluid might include Nitrogen gas or Argon gas. A pressure gauge, not shown in FIG. 1, may also be in fluidic connection with interior volumes 121a and 131a whereby the internal pressure may be monitored.

In a further alternate embodiment, it may be found that a lower degree of atmospheric control is sufficient whereby secondary storage container 130 may not require the maintenance of an isolated atmosphere when detached from primary storage container 120. In this instance secondary storage container may not have storage valve 133 or media transport pathway 132 and instead, valve-dock media transport pathway 134 may be directly connected to storage chamber 131.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A storage device comprising:
a chamber with an interior volume configured to receive media in fluid connection with a storage valve configured to selectively control the flow of media and ambient atmosphere, the storage valve in fluid communication with a dock configured to sealingly engage with an additional storage device;
the dock configured to facilitate the passage of media without exposure to an ambient atmosphere.
